(19) United States
(12) Patent Application Publication
(10) Pub. No.: US 2025/0325043 A1
(43) Pub. Date: Oct. 23, 2025

(54) METHOD OF MANUFACTURING HEATER ASSEMBLY FOR AEROSOL-GENERATING DEVICES

(71) Applicant: KT&G CORPORATION, Daejeon (KR)

(72) Inventors: Dongsung KIM, Seoul (KR); Youngbum KWON, Gyeonggi-do (KR); Yonghwan KIM, Gyeonggi-do (KR); Hwikyeong AN, Seoul (KR)

(73) Assignee: KT&G CORPORATION, Daejeon (KR)

(21) Appl. No.: 19/095,442

(22) Filed: Mar. 31, 2025

(30) Foreign Application Priority Data
Apr. 23, 2024 (KR) 10-2024-0053873

(51) Int. Cl. A24F 40/70; A24F 40/46

(52) U.S. Cl. CPC A24F 40/70; A24F 40/46

(57) ABSTRACT

A method of manufacturing a heater assembly for aerosol-generating devices is disclosed. The method includes preparing a sheet formed to be elongated, placing a susceptor and an electrically conductive track on the sheet, and rolling the sheet around a main roller, with the susceptor and the electrically conductive track placed on the sheet. The rolling includes rolling the sheet around the outer circumferential surface of the main roller while allowing the sheet to sequentially pass through spaces defined between the main roller and each of a plurality of sub-rollers adjacent to the main roller.

### CROSS-REFERENCE TO RELATED APPLICATIONS

Pursuant to 35 U.S.C. § 119(a), this application claims the benefit of earlier filing date and right of priority to Korean Patent Application No. 10-2024-0053873 filed on Apr. 23, 2024, the contents of which are all hereby incorporated by reference herein in their entireties.

### BACKGROUND OF THE DISCLOSURE

### 1. Field of the disclosure

The present disclosure relates to a method of manufacturing a heater assembly for aerosol-generating devices.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

In general, an insulator using a polyimide film is used for a cylindrical external heater that receives an aerosol-generating substance therein and heats the same. As an aerosol-generating device is used in various environments such as a high-temperature and high-humidity environment, a film insulator of a heater may swell, or a portion of the film insulator may be lifted or delaminated from a heat generator.

In addition, in the case of an external heater having a structure in which a film insulator is rolled multiple times, layers may not be firmly pressed and some of the layers may be lifted during the process of manufacturing the heater.

### SUMMARY OF THE DISCLOSURE

It is an object of the present disclosure to solve the above and other problems.

It is another object of the present disclosure to provide a method of manufacturing a heater assembly in which a sheet is rolled around a main roller while sequentially passing through spaces defined between the main roller and respective sub-rollers.

It is still another object of the present disclosure to provide a method of manufacturing a heater assembly in which the sheet is heated by the main roller and is heated and pressed by the sub-rollers.

It is still another object of the present disclosure to provide a method of manufacturing a heater assembly in which a susceptor and an electrically conductive track disposed on the sheet are rolled around the main roller together with the sheet and then are thermally fused to the sheet.

It is still another object of the present disclosure to provide a method of manufacturing a heater assembly in which multiple layers including any one of the susceptor, the electrically conductive track, and the sheet are formed.

It is still another object of the present disclosure to provide a method of manufacturing a heater assembly in which a sheet heating time, pressure, and temperature set within predetermined ranges are used.

In accordance with an aspect of the present disclosure for accomplishing the above and other objects, there is provided a method of manufacturing a heater assembly for aerosol-generating devices, the method including preparing a sheet formed to be elongated, placing a susceptor and an electrically conductive track on the sheet, and rolling the sheet around a main roller, with the susceptor and the electrically conductive track placed on the sheet, wherein the rolling includes rolling the sheet around the outer circumferential surface of the main roller while allowing the sheet to sequentially pass through spaces defined between the main roller and each of a plurality of sub-rollers adjacent to the main roller.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features, and other advantages of the present disclosure will be more clearly understood from the following detailed description taken in conjunction with the accompanying drawings, in which:

FIGS. 1 and 2 are views showing an aerosol-generating device according to embodiments of the present disclosure;

FIG. 3 is an exploded perspective view of a heater assembly according to an embodiment of the present disclosure;

FIG. 4 is a cross-sectional view of the heater assembly according to the embodiment of the present disclosure;

FIG. 5 is a view showing an electrically conductive track of the heater assembly according to the embodiment of the present disclosure;

FIG. 6 is a flowchart showing a method of manufacturing the heater assembly according to an embodiment of the present disclosure;

FIG. 7 is a view showing a state in which a susceptor and the electrically conductive track are placed on a sheet in the heater assembly according to the embodiment of the present disclosure;

FIGS. 8 to 10 are views showing a process of rolling the sheet around a main roller in the heater assembly manufacturing method according to the embodiment of the present disclosure;

FIG. 11 is a view showing a process of assembling brackets and casings in the heater assembly manufacturing method according to the embodiment of the present disclosure;

FIG. 12 is an image illustrating swelling and lifting of an insulator that may occur with the use of the heater assembly according to the embodiment of the present disclosure; and

FIG. 13 is a block diagram of an aerosol-generating device according to an embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout this specification, the directions of an apparatus for manufacturing a heater assembly for aerosol-generating devices and the directions of a sheet may be defined based on an orthogonal coordinate system. In the orthogonal coordinate system, the x-axis direction may be defined as a leftward-rightward direction of the manufacturing apparatus. The y-axis direction may be defined as a forward-backward direction of the manufacturing apparatus. The z-axis direction may be defined as an upward-downward direction of the manufacturing apparatus.

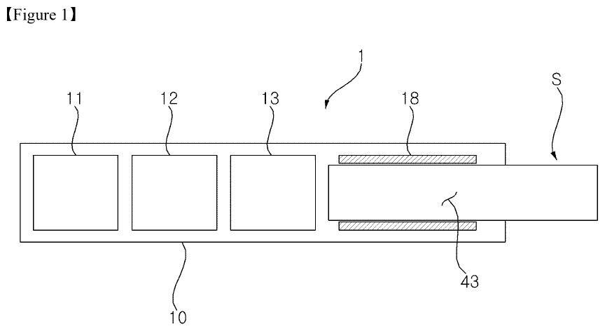

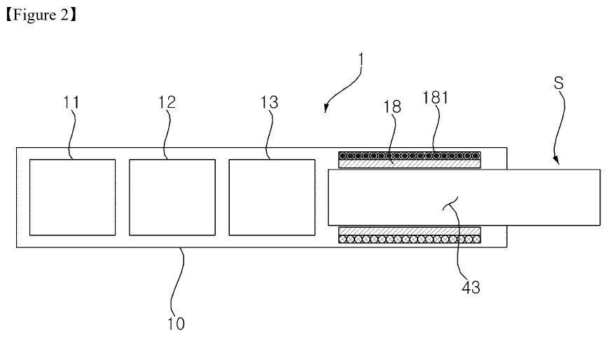

FIGS. 1 and 2 are views showing aerosol-generating devices 1 according to embodiments of the present disclosure.

Referring to FIGS. 1 and 2, an aerosol-generating device 1 according to embodiments of the present disclosure may include at least one of a power supply 11, a controller 12, a sensor 13, or a heater 18. At least one of the power supply 11, the controller 12, the sensor 13, or the heater 18 may be disposed in a body 10 of the aerosol-generating device. The body 10 may define a space having an open top to allow a stick S, which is an aerosol-generating article, to be inserted thereinto. The space having an open top may be referred to as an insertion space 43. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat a stick S. The heater 18 may be disposed around a space into which the stick S is inserted and may be elongated upward. For example, the heater 18 may be formed in a shape of a tube including a cavity formed therein. The heater 18 may be disposed around an insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, referring to FIG. 1, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, referring to FIG. 2, the aerosol-generating device may include an induction coil 181 surrounding the heater 18. The induction coil 181 may cause the heater 18 to generate heat. The heater 18 may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

The power supply 11 may supply power so that components of the aerosol-generating device operate. The power supply 11 may be referred to as a battery. The power supply 11 may supply power to at least one of the controller 12, the sensor 13, or the heater 18. The power supply 11 may supply power to the induction coil 181.

The controller 12 may control overall operation of the aerosol-generating device. The controller may be mounted on a printed circuit board (PCB). The controller 12 may control operation of at least one of the power supply 11, the sensor 13, or the heater 18. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

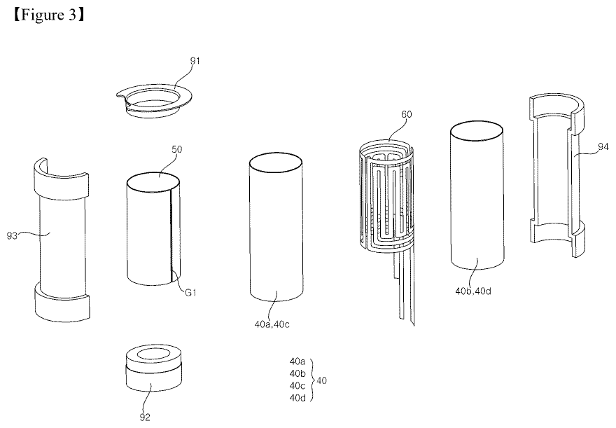

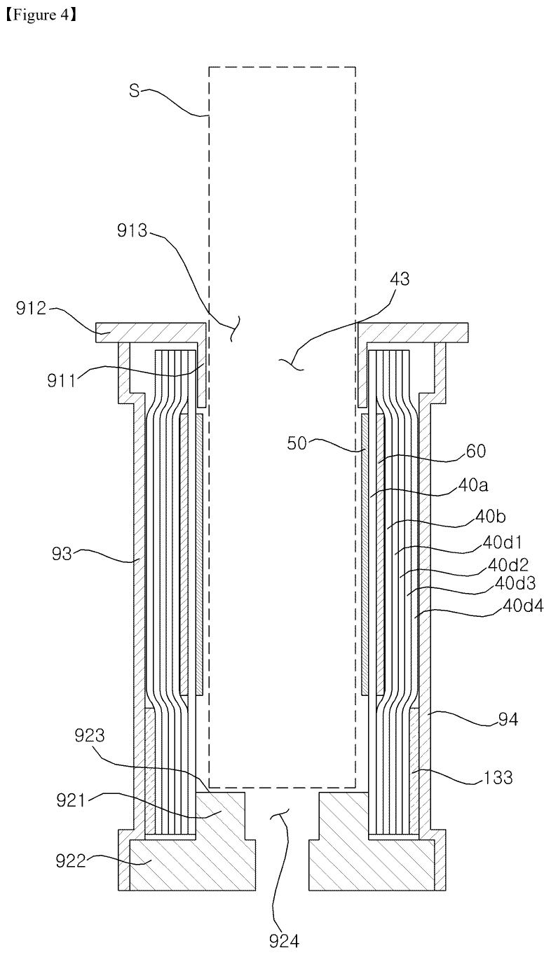

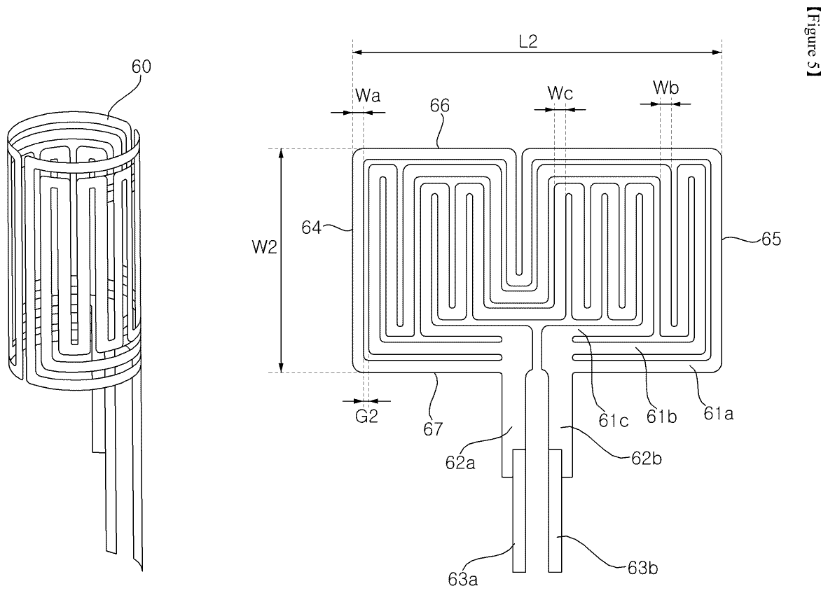

FIG. 3 is an exploded perspective view of a heater assembly according to an embodiment of the present disclosure, FIG. 4 is a cross-sectional view of the heater assembly according to the embodiment of the present disclosure, and FIG. 5 is a view showing an electrically conductive track of the heater assembly according to the embodiment of the present disclosure.

Referring to FIGS. 3 and 4, the heater 18 may be disposed in the body 10. The heater 18 may be referred to as a heater assembly. The heater assembly 18 may have a tubular shape or a cylindrical shape including a cavity formed therein. The heater assembly 18 may surround the insertion space 43. The heater assembly 18 may provide the insertion space 43. The insertion space 43 or the stick S inserted into the insertion space 43 may be heated by the heater assembly 18.

The heater assembly 18 may include a susceptor 50, an electrically conductive track 60, and an insulator 40.

The susceptor 50 may have a cylindrical shape. The susceptor 50 may be disposed at the innermost portion of the hollow heater assembly 18. The susceptor 50 may be disposed inside the electrically conductive track 60. The susceptor 50 may surround at least a portion of the insertion space 43. At least a portion of the inner circumferential surface of the susceptor 50 may be in contact with the outer circumferential surface of the stick S inserted into the insertion space 43. The susceptor 50 may be referred to as a heat conductor, a heat conducting part, a heat diffusing part, or a pipe. The susceptor 50 may be made of stainless steel, aluminum, or an alloy thereof without being limited thereto.

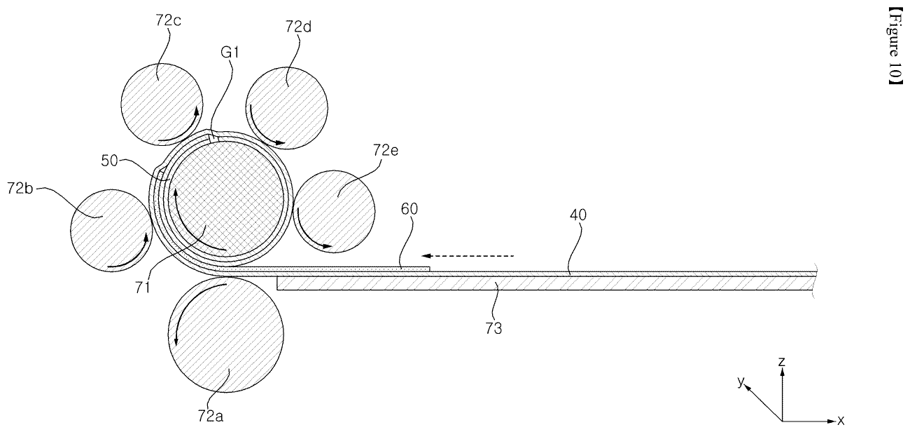

One end of the susceptor 50 may be spaced apart from the other end of the susceptor 50 in the peripheral direction of the susceptor 50 or the peripheral direction of the insertion space 43. A gap G1 (refer to FIG. 10) may be formed between one end and the other end of the susceptor 50. The gap G1 may be elongated in the longitudinal direction of the insertion space 43. As the width of the gap G1 increases, the area of a portion of the stick S that is not heated due to the gap G1 may increase. Therefore, the gap G1 may correspond to an upper limit width at which an aerosol is generated from the stick S in a preset minimum required amount or more.

Accordingly, it may be possible to prevent a phenomenon that the shape of the susceptor 50 is distorted or parts of the susceptor 50 overlap each other in the process of manufacturing the susceptor 50 or the process in which the susceptor 50 is heated or cooled.

The electrically conductive track 60 may have a cylindrical shape. The electrically conductive track 60 may be disposed outside the susceptor 50. The electrically conductive track 60 may surround at least a portion of the susceptor 50. The electrically conductive track 60 may generate heat in response to power received from the power supply 11. The electrically conductive track 60 may be referred to as a heat-generating part. The electrically conductive track 60 may be formed by etching a thin metal film using a laser. The electrically conductive track 60 may be made of stainless steel, copper, aluminum, or alloys thereof without being limited thereto.

An insulator 40 may be disposed on one side of the electrically conductive track 60. The insulator 40 may be disposed inside and/or outside the electrically conductive track 60 and may have a cylindrical shape. The insulator 40 may cover the electrically conductive track 60. The insulator 40 may extend farther upward and downward than the electrically conductive track 60 in the longitudinal direction of the insertion space 43. The insulator 40 may be disposed between the susceptor 50 and the electrically conductive track 60 and outside the electrically conductive track 60 in the radial direction of the insertion space 43.

The insulator 40 may be formed of a flexible and heat-resistant material. The insulator 40 may include, but is not limited to, polyimide or polyetheretherketone (PEEK), and may include other materials having elasticity, heat resistance, and electrical insulation.

Brackets 91 and 92 may be coupled to the upper end and the lower end of the heater assembly 18. The brackets 91 and 92 may include a first bracket 91 attached or coupled to an upper side of the heater assembly 18 corresponding to the opening of the insertion space 43 and a second bracket 92 attached or coupled to a lower side of the heater assembly 18.

The first bracket 91 may have a cylindrical shape overall, and may include a flange 912 protruding from the upper end portion thereof in the radially outward direction. A lower side of a first bracket body 911 may be attached to or press-fitted into the upper end portion of the heater assembly 18. The first bracket 91 may include an insertion hole 913 formed through the central portion thereof in the upward-downward direction. One side of the flange 912 may be depressed in the radially inward direction to form an alignment recess. The alignment recess may have a shape corresponding to a protrusion formed at the body 10. The alignment recess may be coupled to the protrusion formed at the body 10. Due to the alignment recess, the heater assembly 18 may be prevented from rotating in the body 10 and may be stably coupled to the body 10.

The second bracket 92 may have a cylindrical shape overall, and may include a flange 922 protruding from the lower end portion thereof in the radially outward direction. An upper side of a second bracket body 921 may be attached to or press-fitted into the lower end portion of the heater assembly 18. The second bracket 92 may include a hole 924 formed through the central portion thereof in the upward-downward direction.

The insertion hole 913 in the first bracket 91 may communicate with an upper side of the insertion space 43. The hole 924 in the second bracket 92 may communicate with a lower side of the insertion space 43. The stick S may be inserted into the insertion space 43 through the insertion hole 913. Outside air may flow into the stick S via an end portion of the stick S through the hole 924 from the outside of the heater assembly 18. The inner circumferential surface of the first bracket body 911 may support at least a portion of the outer circumferential surface of the stick S inserted into the insertion space 43. The upper surface 923 of the second bracket body 921 may support at least a portion of the lower end of the stick S inserted into the insertion space 43.

Accordingly, both ends of the heater assembly 18 including the susceptor 50 and the electrically conductive track 60 may be stably fixed, and thus the rigidity of the heater assembly 30 may be ensured.

The brackets 91 and 92 may be made of stainless steel, aluminum, polyetheretherketone (PEEK), or alloys thereof without being limited thereto.

A stick detection sensor 133 (refer to FIG. 4) may be disposed on the heater assembly 18. The stick detection sensor 133 may detect insertion and/or removal of the stick S. The stick detection sensor 133 may be disposed so as to surround at least a portion of the lower side of the heater assembly 18. The stick detection sensor 133 may be disposed below the susceptor 50 and the electrically conductive track 60 in the longitudinal direction of the insertion space 43. The stick detection sensor 133 may be disposed so as to be in contact with the portion of the insulator 40 that extends downward below the electrically conductive track 60 and to surround a portion of the periphery of the insulator 40. The stick detection sensor 133 may be spaced apart from the susceptor 50 and the electrically conductive track 60 in the longitudinal direction of the insertion space 43.

Accordingly, transfer of heat generated by the susceptor 50 and the electrically conductive track 60 to the sensor 133 may be minimized. In addition, the accuracy of detection of the stick S by the sensor 133 may be increased.

Casings 93 and 94 may be coupled to a side surface of the heater assembly 18. The casings 93 and 94 may include a first casing 93 surrounding a portion of the side surface of the heater assembly 18 and a second casing 94 surrounding the remaining portion of the side surface of the heater assembly 18. The first casing 93 and the second casing 94 may be coupled to surround the side surface of the heater assembly 18. The first casing 93 and the second casing 94 may be combined with the brackets 91 and 92 coupled to the upper and lower ends of the heater assembly 18.

Accordingly, the heater assembly 18 including the susceptor 50 and the electrically conductive track 60 may be protected from the outside, and the rigidity of the heater assembly 18 may be ensured.

Referring to FIG. 5, the electrically conductive track 60 may have a cylindrical shape. The electrically conductive track 60 may generate heat in response to power received from the power supply 11. Heat generated from the electrically conductive track 60 may heat a medium and/or a moisturizer in the stick S inserted into the insertion space 43, whereby an aerosol may be generated.

The electrically conductive track 60 may have a rolled-cylindrical shape. The resistance value of the electrically conductive track 60 may be 1.0 to 1.2 ohms. The electrically conductive track 60 may be elongated in one direction and may have a rectangular shape in which the length L2 thereof is greater than the width W2 thereof. The length L2 of the electrically conductive track 60 may be 18 mm to 28 mm, and the width W2 of the electrically conductive track 60 may be 10 mm to 20 mm. In some embodiments, the length L2 of the electrically conductive track 60 may be 20.5 mm to 25.5 mm, and the width W2 of the electrically conductive track 60 may be 12.5 mm to 17.5 mm.

The electrically conductive track 60 may include a heat-generating track 61 and a connection portion 62. The heat-generating track 61 may include one or more tracks 61a, 61b, and 61c. The first track 61a may be disposed at the outermost portion of the electrically conductive track 60 and may have a rectangular shape overall. The second track 61b may be disposed inside the first track 61a, and the third track 61c may be disposed inside the second track 61b.

Each of the first to third tracks 61a, 61b, and 61c may include at least one bent portion and may have a serpentine shape. The number of bent portions of the first track 61a may be less than the number of bent portions of the second track 61b. The number of bent portions of the second track 61b may be less than the number of bent portions of the third track 61c. The first to third tracks 61a, 61b, and 61c may be spaced apart from each other. One end of each of the first to third tracks 61a, 61b, and 61c may be connected to one end of each of the other tracks, and the other end of each of the first to third tracks 61a, 61b, and 61c may be connected to the other end of each of the other tracks. In other words, the first to third tracks 61a, 61b, and 61c may be connected in parallel to each other.

The width Wa of the first track 61a may be 0.5 mm to 0.7 mm. The width Wb of the second track 61b may be 0.6 mm to 0.8 mm. The width Wc of the third track 61c may be 0.65 mm to 0.85 mm. A gap G2 by which the second track 61b is spaced apart from the first track 61a or the third track 61c may be 0.3 mm to 0.4 mm.

The width Wa of the first track 61a may be less than the width Wb of the second track 61b and the width Wc of the third track 61c. The width Wb of the second track 61b may be less than the width Wc of the third track 61c. The gap G2 by which the second track 61b is spaced apart from the first track 61a or the third track 61c may be less than the width Wa of the first track 61a, the width Wb of the second track 61b, and the width Wc of the third track 61c.

The length of the first track 61a may be less than the length of the second track 61b and the length of the third track 61c.

Accordingly, resistance deviation between the first track 61a disposed at the outermost portion of the electrically conductive track 60, the second track 61b disposed inside the first track 61a, and the third track 61c disposed inside the second track 61b may be reduced, and deviation between the amounts of heat generated from the respective tracks may be reduced.

In addition, because the gap between the tracks is less than the widths of the tracks, the heat-generating area of the electrically conductive track 60 may be increased, and the insertion space 43 or the stick S inserted into the insertion space 43 may be evenly heated by the electrically conductive track 60.

The connection portion 62 may protrude outwardly from one side of the heat-generating track 61. The connection portion 62 may be integrally formed with the heat-generating track 61. The connection portion 62 may include a first connection portion 62a and a second connection portion 62b. The first connection portion 62a may be connected to one end of each of the first to third tracks 61a, 61b, and 61c, and the second connection portion 62b may be connected to the other end of each of the first to third tracks 61a, 61b, and 61c.

A lead 63 may be connected to the electrically conductive track 60. The lead 63 may be connected to the connection portion 62. The lead 63 may be elongated in the direction in which the connection portion 62 protrudes. The lead 63 may electrically connect the electrically conductive track 60 to the power supply 11 or a heater driving circuit (not shown). The lead 63 may include a first lead 63a in contact with the first connection portion 62a and a second lead 63b in contact with the second connection portion 62b. Power may be supplied to the electrically conductive track 60 via the first lead 63a and the second lead 63b. The lead 63 may be made of a material having a lower temperature coefficient of resistance (TCR) than the electrically conductive track 60. The lead 63 may be attached to the connection portion 62 through welding, but the disclosure is not limited thereto.

Accordingly, change in the temperature of the electrically conductive track 60 obtained based on the change in the resistance of the electrically conductive track 60 may be accurately measured.

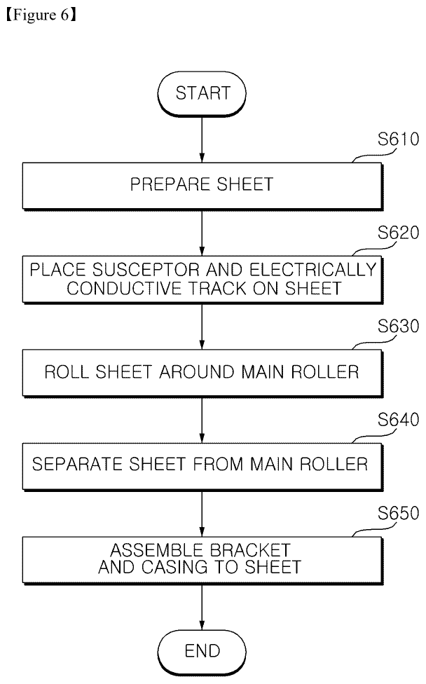

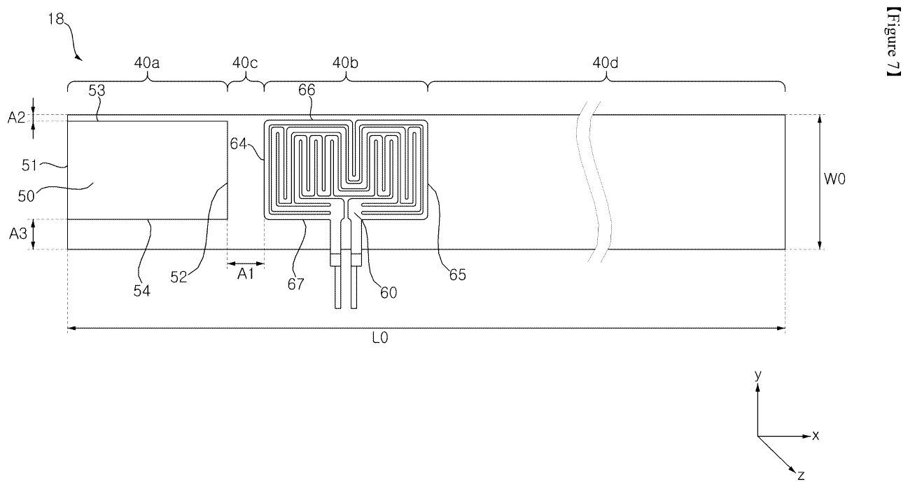

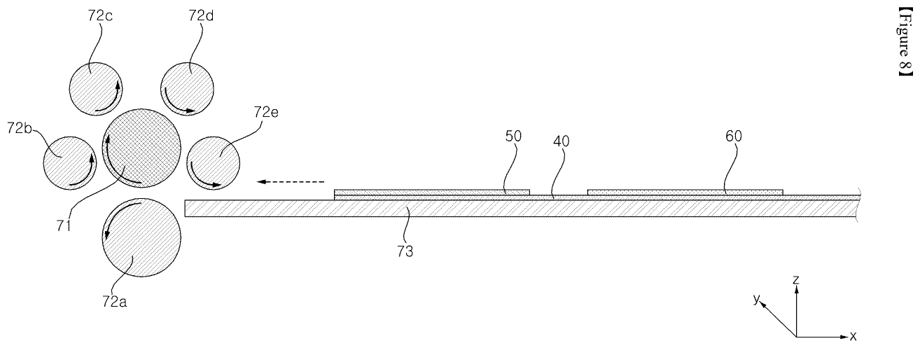

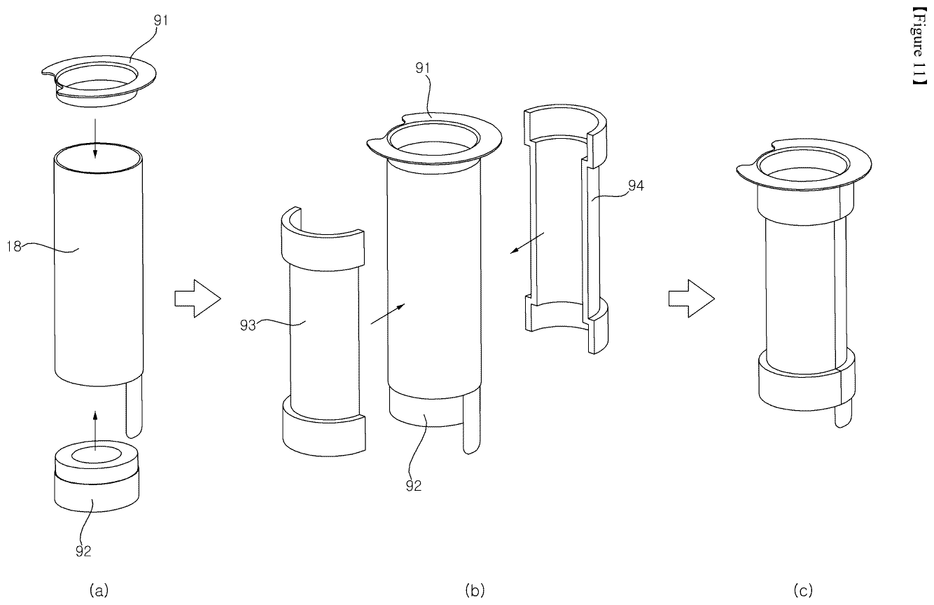

FIG. 6 is a flowchart showing a method of manufacturing the heater assembly according to an embodiment of the present disclosure, FIG. 7 is a view showing a state in which the susceptor and the electrically conductive track are placed on the sheet in the heater assembly according to the embodiment of the present disclosure, FIGS. 8 to 10 are views showing a process of rolling the sheet around a main roller in the heater assembly manufacturing method according to the embodiment of the present disclosure, and FIG. 11 is a view showing a process of assembling the brackets and the casings in the heater assembly manufacturing method according to the embodiment of the present disclosure.

Referring to FIGS. 6 and 7, the method of manufacturing the heater assembly according to the embodiment of the present disclosure includes a step of preparing the sheet 40 (S610), a step of placing the susceptor 50 and the electrically conductive track 60 on the sheet 40 (S620), and a step of rolling the sheet 40 around a main roller 71 (S630).

In step S610, the sheet 40 may be prepared. The sheet 40 may be one sheet elongated in one direction or in the x direction. The sheet 40 may be a flexible sheet, and may be formed of a material having heat resistance. The sheet 40 may be referred to as an insulator or an insulating sheet. The sheet 40 may include, but is not limited to, polyimide or polyetheretherketone (PEEK), and may include other materials having elasticity, heat resistance, and electrical insulation.

The length L0 of the sheet 40 may be 120 mm to 160 mm, and the width W0 of the sheet 40 may be 15 mm to 25 mm. In some embodiments, the length L0 of the sheet 40 may be 130 mm to 150 mm, and the width W0 of the sheet 40 may be 17.5 mm to 22.5 mm.

In step S620, the susceptor 50 and the electrically conductive track 60 may be placed on the sheet 40. The susceptor 50 and the electrically conductive track 60 may be sequentially placed in the longitudinal direction of the sheet 40. The susceptor 50 and the electrically conductive track 60 may be disposed so as to be spaced apart from each other in the longitudinal direction of the sheet 40.

The susceptor 50 and the electrically conductive track 60 may be placed on the same surface of the sheet 40. The sheet 40 may include a first surface that is flat and a second surface that is formed opposite the first surface in the thickness direction thereof. The susceptor 50 and the electrically conductive track 60 may be placed on the first surface of the sheet 40. The sheet 40 may be placed on a feeder 73. The sheet 40 may be placed on the feeder 73 such that the second surface thereof is in contact with the upper surface of the feeder 73.

Because the susceptor 50 and the electrically conductive track 60 are disposed on the same surface of the sheet 40, springback, which is a phenomenon occurring when an elastic object is rolled, may be reduced, and accordingly, defects in the heater assembly may be reduced.

The susceptor 50 may be disposed adjacent to one end of the sheet 40 in the longitudinal direction of the sheet 40. One end 51 of the susceptor 50 may be aligned parallel to one end of the sheet 40. One end 64 of the electrically conductive track 60 may be spaced apart from the other end 52 of the susceptor 50 by a predetermined distance A1. The upper end 53 of the susceptor 50 may be aligned with the upper end 66 of the electrically conductive track 60. The lower end 54 of the susceptor 50 may be aligned with the lower end 67 of the electrically conductive track 60.

The susceptor 50 may be disposed closer to the main roller 71 than the electrically conductive track 60 in the longitudinal direction of the sheet 40.

The width WO of the sheet 40 may be greater than the width W1 of the susceptor 50 and the width W2 of the electrically conductive track 60. The susceptor 50 and the electrically conductive track 60 may be disposed closer to the upper end of the sheet 40 than to the lower end of the sheet 40 in the width direction of the sheet 40 or in the y direction. A distance A2 by which the upper end 53 of the susceptor 50 and/or the upper end 66 of the electrically conductive track 60 is spaced apart from the upper end of the sheet 40 may be less than a distance A3 by which the lower end 54 of the susceptor 50 and/or the lower end 67 of the electrically conductive track 60 is spaced apart from the lower end of the sheet 40.

A distance A1 by which the susceptor 50 is spaced apart from the electrically conductive track 60 in the longitudinal direction of the sheet 40 may be less than the length L2 of the electrically conductive track 60 defined in the longitudinal direction of the sheet 40. The susceptor 50 and the electrically conductive track 60 may be electrically insulated from each other by the sheet 40. As the distance A1 between the susceptor 50 and the electrically conductive track 60 increases, the number of layers of the sheet 40 disposed between the susceptor 50 and the electrically conductive track 60 in the hollow heater assembly 30 may be increased or the area of the sheet 40 may be increased. When the distance A1 between the susceptor 50 and the electrically conductive track 60 is less than the length L2 of the electrically conductive track 60, the number of layers of the sheet 40 disposed between the susceptor 50 and the electrically conductive track 60 may be two or less.

Accordingly, heat generated from the electrically conductive track 60 may be more efficiently transferred to the susceptor 50.

In the longitudinal direction of the sheet 40, the length L2 of the electrically conductive track 60 may be greater than the length L1 of the susceptor 50. In the hollow heater assembly 30, the electrically conductive track 60 may surround the susceptor 50 outside the susceptor 50. Because the length L2 of the electrically conductive track 60 is greater than the length L1 of the susceptor 50, the area of the portion of the electrically conductive track 60 that surrounds the susceptor 50 may be increased.

Accordingly, the area of transfer of heat from the electrically conductive track 60 to the susceptor 50 may be increased, and the insertion space 43 or the stick S in the insertion space 43 may be more evenly heated by the susceptor 50 and the electrically conductive track 60. In addition, because the area of the electrically conductive track 60 is increased, freedom of design of the shape of the track may be increased.

The sheet 40 may include first to fourth parts 40a, 40b, 40c, and 40d. The susceptor 50 may be disposed on the first part 40a. The electrically conductive track 60 may be disposed on the second part 40b. The third part 40c may be disposed between the first part 40a and the second part 40b in the longitudinal direction of the sheet 40 and may be connected to the first part 40a and the second part 40b. The fourth part 40d may extend from the second part 40b in the longitudinal direction of the sheet 40 and may be opposite the third part 40c with respect to the second part 40b.

The first part 40a may be disposed closer to the main roller 71 than the second to fourth parts 40b, 40c, and 40d in the longitudinal direction of the sheet 40. The first part 40a may be rolled around the main roller 71 earlier than the second to fourth parts 40b, 40c, and 40d, and may be disposed farther inward than the second to fourth parts 40b, 40c, and 40d in the radial direction of the hollow heater assembly 18.

Referring to FIG. 8 together with FIG. 6, in step S630, the sheet 40 may be rolled around the main roller 71. The sheet 40 may be wound around the main roller 71. One end of the sheet 40 may first be rolled around the main roller 71 in the state in which the sheet 40 is disposed on the feeder 73. The sheet 40 may be moved toward the main roller 71 by the feeder 73. The feeder 73 may include a belt (not shown) and may move the sheet 40 toward the main roller 71 while being driven at a constant speed toward the main roller 71 or in the x direction by a driving device (not shown).

The main roller 71 may be rotated in one direction. The main roller 71 may be rotated at a constant angular speed for a set time period. The diameter of the main roller 71 may be 7 mm to 8 mm. A plurality of sub-rollers 72 may be disposed along the periphery of the main roller 71. The plurality of sub-rollers 72 may be spaced apart from each other along the periphery of the main roller 71 and may be disposed adjacent to the outer circumferential surface of the main roller 71. The plurality of sub-rollers 72 may be rotated in a direction opposite the rotation direction of the main roller 71. The plurality of sub-rollers 72 may be rotated at a constant angular speed for a set time period.

Spaces or gaps may be formed between the respective sub-rollers 72 and the outer circumferential surface of the main roller 71. The sheet 40 may sequentially pass through the spaces between the respective sub-rollers 72 and the outer circumferential surface of the main roller 71 in the peripheral direction of the main roller 71. For example, the sheet 40 may sequentially pass through a first space between the main roller 71 and the first sub-roller 72a, a second space between the main roller 71 and the second sub-roller 72b, a third space between the main roller 71 and the third sub-roller 72c, a fourth space between the main roller 71 and the fourth sub-roller 72d, and a fifth space between the main roller 71 and the fifth sub-roller 72e. The sheet 40 may form one layer on the outer side of the main roller 71 while sequentially passing through the first to fifth spaces. Thereafter, the sheet 40 may form another layer on the outer side of the previously formed layer while sequentially passing through the first to fifth spaces again.

Accordingly, during the process of manufacturing the heater assembly 18, the layers of the sheet 40 may be firmly pressed against each other, and lifting of some of the layers may be prevented.

At least one of the plurality of sub-rollers 72 may have a different diameter from the other sub-rollers 72.

For example, the diameter of the first sub-roller 72a may be greater than the diameters of the second to fifth sub-rollers 72b, 72c, 72d, and 72e. When the diameter of the sub-roller is relatively large, the curvature of the outer circumferential surface thereof is smaller than when the diameter thereof is relatively small, and accordingly, the sheet 40 passing between the sub-roller and the main roller 71 may be pressed more evenly. Because the diameter of the first sub-roller 72a that first presses the sheet 40 is greater than the diameters of the other sub-rollers, the sheet 40 may be stably rolled around the main roller 71, and lifting of a portion of the sheet 40 during the rolling process may be prevented.

When the diameter of the sub-roller is relatively small, the number of sub-rollers capable of being disposed along the periphery of the main roller 71 may be increased compared to when the diameter thereof is relatively large. Because the diameters of the remaining second to fifth sub-rollers 72b, 72c, 72d, and 72e are formed to be less than the diameter of the first sub-roller 72a, the number of sub-rollers disposed along the periphery of the main roller 71 may be increased, thereby stably rolling the sheet 40 around the main roller 71.

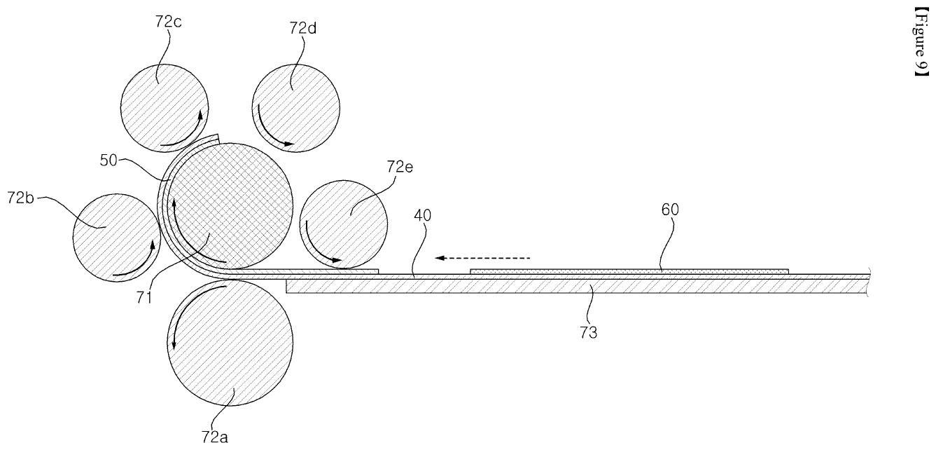

Referring to FIG. 9 together with FIG. 6, in step S630, the susceptor 50 and the electrically conductive track 60 may be rolled around the main roller 71 together with the sheet 40. The sheet 40 may be rolled around the main roller 71 so that the susceptor 50 faces the outer circumferential surface of the main roller 71. The susceptor 50 may be rolled around the outer circumferential surface of the main roller 71 while being moved together with the sheet 40 in the state of being disposed on the sheet 40. The susceptor 50 may form a first layer on the outer side of the main roller 71. The first part 40a of the sheet 40 that is in contact with the susceptor 50 may form a second layer on the outer side of the first layer formed by the susceptor 50.

The main roller 71 may be heated to a constant temperature. The main roller 71 may include a heat generator disposed adjacent to the outer circumferential surface thereof. The main roller 71 may be heated by the heat generator. The sheet 40 and the susceptor 50 rolled around the outer circumferential surface of the main roller 71 may be heated by the main roller 71. The plurality of sub-rollers 72 may press the sheet 40 and the susceptor 50 together with the main roller 71. The susceptor 50 may be heated and pressed by the main roller 71 and the plurality of sub-rollers 72 and thus may be thermally fused to the sheet 40.

Accordingly, the process of manufacturing the heater assembly 18 may be simplified, and the bonding structure of the heater assembly 18 may be simplified.

Referring to FIG. 10 together with FIG. 6, in step S630, the sheet 40 may be rolled around the main roller 71 so that the electrically conductive track 60 faces the outer circumferential surface of the main roller 71. The electrically conductive track 60 may be rolled around the main roller 71 while being moved together with the sheet 40 in the state of being disposed on the sheet 40. The electrically conductive track 60 may form a third layer on the outer side of the main roller 71. The second part 40b of the sheet 40 that is in contact with the electrically conductive track 60 may form a fourth layer on the outer side of the third layer formed by the electrically conductive track 60.

The electrically conductive track 60 rolled around the main roller 71 may be heated together with the sheet 40 by the main roller 71. The plurality of sub-rollers 72 may press the sheet 40 and the electrically conductive track 60 together with the main roller 71. The electrically conductive track 60 may be heated and pressed by the main roller 71 and the plurality of sub-rollers 72 and thus may be thermally fused to the sheet 40.

The space between each of the sub-rollers 72 and the outer circumferential surface of the main roller 71 may vary in width. For example, each of the sub-rollers 72 may be moved in the radial direction of the main roller 71. Each of the sub-rollers 72 may be provided to be rotatable along the rotation shaft thereof, and the rotation shaft of each of the sub-rollers 72 may be provided to be movable in the radial direction of the main roller 71. In order to allow each of the sub-rollers 72 to press the sheet 40 toward the center of the main roller 71 at a constant pressure, a driving device for moving each of the sub-rollers 72 in the radial direction of the main roller 71 may be connected to the rotation shaft of each of the sub-rollers 72. The driving device may include a motor, a gear, and a pressure sensor in order to move the rotation shaft of each of the sub-rollers 72 in the radial direction of the main roller 71. Each of the sub-rollers 72 may be moved in the radial direction of the main roller 71 together with the rotation shaft that is moved by the driving device and may press the sheet 40 rolled around the main roller 71.

When each of the sub-rollers 72 is moved in the radial direction of the main roller 71, the shortest distance or the width of the space between each of the sub-rollers 72 and the outer circumferential surface of the main roller 71 may be increased or reduced.

Accordingly, even when the sheet 40 is rolled around the outer circumferential surface of the main roller 71 and at least one layer is formed on the outer circumferential surface of the main roller 71, the sheet 40 rolled around the main roller 71 may be constantly pressed at a set pressure.

Referring back to FIG. 6, in step S630, at least one of the plurality of sub-rollers 72 may be heated. At least one of the plurality of sub-rollers 72 may include a heat generator disposed adjacent to the outer circumferential surface thereof. At least one of the plurality of sub-rollers 72 may be heated by the heat generator. For example, the main roller 71 may be heated to a first temperature, and at least one of the plurality of sub-rollers 72 may be heated to a second temperature. The second temperature may be equal to or lower than the first temperature. The sheet 40, the susceptor 50, and the electrically conductive track 60 rolled around the outer circumferential surface of the main roller 71 may be heated by the main roller 71 and at least one of the plurality of sub-rollers 72. The plurality of sub-rollers 72 may heat and press the sheet 40, the susceptor 50, and the electrically conductive track 60 together with the main roller 71. The susceptor 50 and the electrically conductive track 60 may be heated and pressed by the main roller 71 and the plurality of sub-rollers 72 and thus may be thermally fused to the sheet 40.

Because the sheet 40, the susceptor 50, and the electrically conductive track 60 are heated by at least one of the plurality of sub-rollers 72, the layers of the sheet 40 may be firmly pressed against each other during the process of manufacturing the heater assembly 18, and gas generated in the sheet 40 may be discharged outside during the manufacturing process.

Referring to FIG. 4 together with FIG. 6, in step S630, the sheet 40 may be rolled in a direction from one end of the first part 40a toward one end of the fourth part 40d. In the hollow heater assembly 18, the second part 40b may be disposed on the outer side of the first part 40a, and the fourth part 40d may be disposed on the outer side of the second part 40b.

The sheet 40 may be rolled around the outer circumferential surface of the main roller 71 at least three turns. For example, the sheet 40 may be rolled around the main roller 71 to form a first layer 40a including the susceptor 50. The first layer may be formed by the first part. The susceptor 50 may form one layer on the inner side of the first layer 40a, and the first layer 40a may surround the outer side of the layer formed by the susceptor 50. The sheet 40 may be rolled around the main roller 71 to form a second layer 40b including the electrically conductive track 60. The second layer may be formed by the second part. The second layer 40b may be disposed on the outer side of the first layer 40a in the radial direction of the main roller 71. The electrically conductive track 60 may form one layer on the inner side of the second layer 40b, and the second layer 40b may surround the outer side of the layer formed by the electrically conductive track 60. The sheet 40 may be rolled around the main roller 71 to form a third layer 40d. The third layer may be formed by the fourth part. The third layer 40d may be disposed on the outer side of the second layer 40b in the radial direction of the main roller 71. The third layer 40d may form one to four layers in the radial direction of the main roller 71. For example, the third layer 40d may form four layers 40d1, 40d2, 40d3, and 40d4.

Accordingly, when the electrically conductive track 60 generates heat, transfer of the heat generated from the electrically conductive track 60 to the outside of the heater assembly 18 may be minimized, and the thermal efficiency of the heater assembly 18 may be increased.

Referring to FIG. 11 together with FIG. 6, the method of manufacturing the heater assembly according to the embodiment of the present disclosure may further include, after step S630, a step of separating the sheet 40 from the main roller 71 (S640) and a step of assembling the brackets 91 and 92 and the casings 93 and 94 to the sheet 40 (S650).

In step S640, the sheet 40 rolled in a hollow shape may be separated from the main roller 71. For example, after step S630, the plurality of sub-rollers 72 may be separated from the main roller 71, and the sheet 40 rolled in a hollow shape may be separated from the main roller 71 in the axial direction of the main roller 71.

In step S650, the brackets 91 and 92 may be assembled to the sheet 40 rolled in a hollow shape. The first bracket 91 may be attached to or press-fitted into one open end of the hollow sheet 40. The second bracket 92 may be attached to or press-fitted into the other open end of the hollow sheet 40.

The sheet 40 rolled in a hollow shape may contain the susceptor 50 and the electrically conductive track 60 thereinside. The sheet 40 rolled in a hollow shape, the susceptor 50, and the electrically conductive track 60 may constitute the heater assembly 18. The first bracket 91 and the second bracket 92 may be attached to or press-fitted into both ends of the hollow sheet 40, thereby stably fixing both ends of the heater assembly 18 including the susceptor 50 and the electrically conductive track 60 and thus ensuring the rigidity of the heater assembly 18.

In step S650, the casings 93 and 94 may be assembled to the side surface of the sheet 40 rolled in a hollow shape. The first casing 93 may be coupled to the side surface of the sheet 40 rolled in a hollow shape. The first casing 93 may surround a portion of the side surface of the heater assembly 18. The second casing 94 may be coupled to the side surface of the sheet 40 rolled in a hollow shape. The second casing 94 may surround the remaining portion of the side surface of the heater assembly 18. The first casing 93 and the second casing 94 may include couplers. A protrusion or a recess formed in the first casing 93 may be engaged with a recess or a protrusion formed in the second casing 94. The first casing 93 and the second casing 94 may be combined with the brackets 91 and 92 coupled to the upper and lower ends of the heater assembly 18.

Accordingly, the heater assembly 18 including the susceptor 50 and the electrically conductive track 60 may be protected from the outside, and the rigidity of the heater assembly 18 may be ensured.

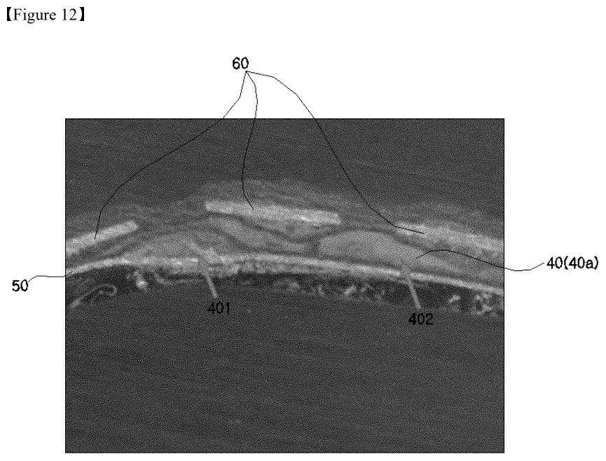

FIG. 12 is an image illustrating swelling and lifting of the insulator that may occur with the use of the heater assembly according to the embodiment of the present disclosure. Referring to FIG. 12 together with FIG. 6, in step S630, the sheet 40 may be heated by the main roller 71 for a set time period, and may be rolled around the main roller 71 while being pressed by the main roller 71 and the plurality of sub-rollers 72. In step S630, the main roller 71 may be heated to a first temperature. For example, the first temperature may be 360° C. to 400° C. In some embodiments, the first temperature may be about 380° C. The sheet 40 may be heated by the heated main roller 71.

In step S630, the plurality of sub-rollers 72 may press the sheet 40 together with the main roller 71 at a first pressure. For example, the first pressure may be 18 kgf to 22 kgf. In some embodiments, the first pressure may be about 20 kgf. The sheet 40 may be pressed at a constant pressure by the plurality of sub-rollers 72 and the main roller 71.

In step S630, the main roller 71 may roll the sheet 40 for a first time period while being rotated at a constant speed. For example, the first time period may be 10 minutes to 14 minutes. In some embodiments, the first time period may be about 12 minutes. The sheet 40 may be rolled around the outer circumferential surface of the main roller 71 at a constant speed for the set first time period.

As the aerosol-generating device 1 including the heater assembly 18 is used by a user, a portion of the insulator 40 constituting the heater assembly 18 may swell or may be lifted from the susceptor 50 or the electrically conductive track 60.

As illustrated in FIG. 12, if a portion of the insulator 40 constituting the heater assembly 18 swells while the electrically conductive track 60 is repeatedly heated and cooled, portions 401 and 402 of the susceptor 50 and/or the electrically conductive track 60 may be lifted from the insulator 40. If a portion of the susceptor 50 and/or the electrically conductive track 60 is lifted from the insulator 40, the shape of the insertion space 43 in the heater assembly 18 may be distorted, and heat generated from the electrically conductive track 60 may not be properly transferred to the susceptor 50. Accordingly, the stick S received in the insertion space 43 may not be normally heated.

Table 1 below shows the swelling/lifting quality of the insulator depending on time, temperature, and pressure in the method of manufacturing the heater assembly according to the embodiment of the present disclosure.

Table 1 below shows the swelling/lifting quality of the insulator 40 depending on a first time period t during which the sheet 40 is rolled around the main roller 71 by rotation of the main roller 71, a first temperature H to which the main roller 71 is heated, and a first pressure P at which the sheet 40 is pressed by the plurality of sub-rollers 72 and the main roller 71.

In Table 1 below, the first time period t, the first temperature H, and the first pressure P mentioned above represent a time period, a temperature, and a pressure set for the process in which the susceptor 50 and the electrically conductive track 60 are placed on the sheet 40 and the sheet 40 is rolled around the main roller 71 together with the susceptor 50 and the electrically conductive track 60 to manufacture the heater assembly 18. The first time period t is divided into a 1-1^{st} time period A and a 1-2^{nd} time period B. The 1-1^{st} time period A represents a time period during which an area from the first part 40a on which the susceptor 50 is disposed to the second part 40b on which the electrically conductive track 60 is disposed is rolled around the main roller 71. The 1-2^{nd} time period B represents a time period during which the fourth part 40d connected to the second part 40b is rolled around the main roller 71.

In Table 1 below, the swelling/lifting quality of the insulator 40 is a result measured after the manufactured heater assembly 18 is left in an environment with a temperature of 60° C. and humidity of 90% for 16 hours. The swelling/lifting quality of the sheet 40 is a result obtained by visually evaluating the degree of swelling of the first layer 40a disposed between the susceptor 50 and the electrically conductive track 60 and the degree of lifting of the first layer 40a from the susceptor 50 or the electrically conductive track 60 in the heater assembly 18 cut in a direction perpendicular to the longitudinal direction thereof. The evaluation was conducted by 10 evaluators, and the evaluated quality was divided into three levels: “Good”, “Medium”, and “Poor”.

TABLE 1

| | | | | Swelling/Lifting |
|---|---|---|---|---|
| Classification | t (sec) | H (° C.) | P (kgf) | Quality of Insulator |
| #1 | A: 120 | 380 | 10 | Poor |
| | B: 240 | | | |
| #2 | A: 240 | 380 | 20 | Good |
| | B: 480 | | | |
| #3 | A: 480 | 320 | 20 | Medium |
| | B: 960 | | | |
| #4 | A: 240 | 380 | 20 | Medium |
| | B: 240 | | | |
| #5 | A: 480 | 320 | 20 | Medium |
| | B: 240 | | | |

Referring to Table 1 above, in the embodiment corresponding to Classification #2, the total heating time A and B and the pressure were doubled, compared to Comparative Example 1 corresponding to Classification #1. In the embodiment, the swelling/lifting quality of the insulator 40 was improved to “Good” level compared to Comparative Example 1.

In Comparative Example 2 corresponding to Classification #3, the total heating time A and B was quadrupled, the pressure was doubled, and the temperature was lowered by 60° C., compared to Comparative Example 1. In Comparative Example 2, the swelling/lifting quality of the insulator 40 was improved to “Medium” level compared to Comparative Example 1.

In Comparative Example 3 corresponding to Classification #4, the 1-1^{st} time period A was doubled and the pressure was doubled, compared to Comparative Example 1.In Comparative Example 3, the swelling/lifting quality of the insulator 40 was improved to “Medium” level compared to Comparative Example 1.

In Comparative Example 4 corresponding to Classification #5, the 1-1^{st} time period A was quadrupled, the pressure was doubled, and the temperature was lowered by 60° C., compared to Comparative Example 1. In Comparative Example 4, the swelling/lifting quality of the insulator 40 was improved to “Medium” level compared to Comparative Example 1.

It can be seen from Table 1 above that the embodiment exhibits the highest insulator swelling/lifting quality compared to Comparative Examples 1 to 4. As described above, according to the embodiment of the present disclosure, because the manufacturing process is performed based on a heating time, pressure, and temperature set within predetermined ranges, it may be possible to prevent the insulator of the heater from swelling or to prevent a portion of the insulator from being lifted or delaminated from the susceptor or the electrically conductive track with the use of the aerosol-generating device.

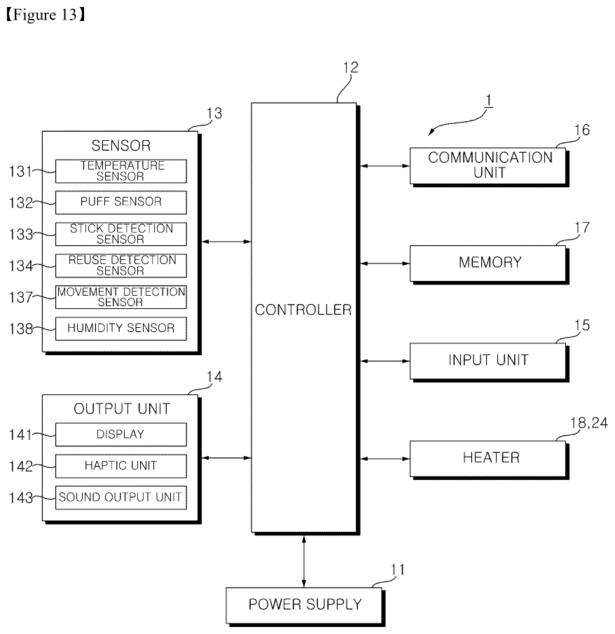

FIG. 13 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 13. That is, it is to be understood by those skilled in the art that some of the components shown in FIG. 13 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a movement detection sensor 137, or a humidity sensor 138.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The stick detection sensor 133 may detect insertion and/or removal of the stick S. The stick detection sensor may be referred to as an insertion detection sensor. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The movement detection sensor 137 may detect movement of the aerosol-generating device. The movement detection sensor 137 may be implemented as at least one of an acceleration sensor or a gyro sensor.

The humidity sensor 138 may detect the humidity of the aerosol-generating device and/or the cartridge. The humidity sensor 138 may detect the humidity of outside air and/or the humidity in the cartridge. The humidity sensor 138 may be implemented as a capacitive sensor or the like. The humidity sensor 138 may be disposed on the outer side of the body 10 or may be located in a path through which outside air is introduced to measure the humidity of the surroundings of the aerosol-generating device 1. The humidity sensor 138 may be located in the storage portion CO of the cartridge 19 to measure the humidity in the cartridge 19.

In addition to the sensors 131 to 138 described above, the sensor 13 may further include at least one of a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the upper case, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 13, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 13, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 13, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 13, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 13, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the upper case has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, because the sheet is rolled around the main roller while sequentially passing through spaces defined between the main roller and the respective sub-rollers, the layers of the sheet may be firmly pressed against each other during the process of manufacturing the heater assembly, and lifting of some of the layers may be prevented.

According to at least one of the embodiments of the present disclosure, because the sheet is heated by the main roller and is heated and pressed by the sub-rollers, the layers of the sheet may be firmly pressed against each other during the process of manufacturing the heater assembly, and gas generated in the sheet may be discharged outside during the manufacturing process.

According to at least one of the embodiments of the present disclosure, because the susceptor and the electrically conductive track disposed on the sheet are rolled around the main roller together with the sheet and then are thermally fused to the sheet, the process of manufacturing the heater assembly may be simplified, and the bonding structure of the heater assembly may be simplified.

According to at least one of the embodiments of the present disclosure, because multiple layers including any one of the susceptor, the electrically conductive track, and the sheet are formed, the size of the device may be reduced, and release of heat to the outside may be minimized.

According to at least one of the embodiments of the present disclosure, because the manufacturing process is performed based on a heating time, pressure, and temperature set within predetermined ranges, it may be possible to prevent the insulator of the heater from swelling or to prevent a portion of the insulator from being lifted or delaminated from the susceptor or the electrically conductive track with the use of the aerosol-generating device.

Referring to FIGS. 1 to 13, a method of manufacturing a heater assembly 18 for aerosol-generating devices in accordance with one aspect of the present disclosure may include preparing a sheet 40 formed to be elongated, placing a susceptor 50 and an electrically conductive track 60 on the sheet 40, and rolling the sheet 40 around a main roller 71, with the susceptor 50 and the electrically conductive track 60 placed on the sheet 40. The rolling may include rolling the sheet 40 around the outer circumferential surface of the main roller 71 while allowing the sheet 40 to sequentially pass through spaces defined between the main roller 71 and each of a plurality of sub-rollers 72 adjacent to the main roller 71.

In addition, in accordance with another aspect of the present disclosure, the plurality of sub-rollers 72 may be disposed so as to be spaced apart from each other in the peripheral direction of the main roller 71 and may be disposed adjacent to the outer circumferential surface of the main roller 71.

In addition, in accordance with another aspect of the present disclosure, the placing may include placing the susceptor 50 and the electrically conductive track 60 to be spaced apart from each other in the longitudinal direction of the sheet 40 and placing the susceptor 50 to be closer to the main roller 71 than the electrically conductive track 60 in the longitudinal direction of the sheet 40.

In addition, in accordance with another aspect of the present disclosure, the placing may include placing the susceptor 50 and the electrically conductive track 60 on the same surface of the sheet 40.

In addition, in accordance with another aspect of the present disclosure, the rolling may include rolling the sheet 40 around the main roller 71 so that the susceptor 50 faces the outer circumferential surface of the main roller 71.

In addition, in accordance with another aspect of the present disclosure, the rolling may include rolling the sheet 40 around the main roller 71 while heating the sheet 40 with the main roller 71 and pressing the sheet 40 with the plurality of sub-rollers 72.

In addition, in accordance with another aspect of the present disclosure, the rolling may include thermally fusing the susceptor 50 and the electrically conductive track 60 to the sheet 40 while heating the susceptor 50 and the electrically conductive track 60 with the main roller 71 and pressing the susceptor 50 and the electrically conductive track 60 with the plurality of sub-rollers 72.

In addition, in accordance with another aspect of the present disclosure, the rolling may include heating the main roller 71 to a first temperature, heating at least one of the plurality of sub-rollers 72 to a second temperature lower than or equal to the first temperature, and heating the sheet 40 rolled around the main roller 71 with the main roller 71 and the plurality of sub-rollers 72.

In addition, in accordance with another aspect of the present disclosure, the rolling may include pressing the sheet 40 at a pressure of 18 kgf to 22 kgf with the main roller 71 and the each of plurality of sub-rollers 72.

In addition, in accordance with another aspect of the present disclosure, the rolling may include heating the main roller 71 to a temperature of 360° C. to 400° C. and heating the sheet 40 rolled around the main roller 71 with the main roller 71.

In addition, in accordance with another aspect of the present disclosure, the rolling may include rolling the sheet 40 around the main roller 71 for 10 minutes to 14 minutes.

In addition, in accordance with another aspect of the present disclosure, the rolling may include rolling the sheet 40 around the outer circumferential surface of the main roller 71 at least three turns.

In addition, in accordance with another aspect of the present disclosure, the rolling may include rolling the sheet 40 around the main roller 71 to form a first layer 40a including the susceptor 50, forming a second layer 40b including the electrically conductive track 60 to be disposed on the outer side of the first layer 40a in the radial direction of the main roller 71, and forming at least one third layer 40d using the sheet 40 to be disposed on the outer side of the second layer 40b in the radial direction of the main roller 71.

In addition, in accordance with another aspect of the present disclosure, the third layer 40d may form one to four layers in the radial direction of the main roller 71.

In addition, in accordance with another aspect of the present disclosure, the method may further include separating the sheet 40 rolled in a hollow shape from the main roller 71, assembling brackets 91 and 92 to both open ends of the rolled sheet 40, and assembling casings 93 and 94 to a side of the rolled sheet 40.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as restrictive in all respects but should be considered as illustrative. The scope of the present disclosure should be determined by reasonable interpretation of the appended claims, and all changes within the equivalent scope of the present disclosure are embraced within the scope of the present disclosure.

What is claimed is:

1. A method of manufacturing a heater assembly for aerosol-generating devices, the method comprising:
preparing a sheet formed to be elongated;
placing a susceptor and an electrically conductive track on the sheet; and
rolling the sheet around a main roller, with the susceptor and the electrically conductive track placed on the sheet,
wherein the rolling comprises rolling the sheet around an outer circumferential surface of the main roller while allowing the sheet to sequentially pass through spaces defined between the main roller and each of a plurality of sub-rollers adjacent to the main roller.

2. The method according to claim 1, wherein the plurality of sub-rollers is disposed so as to be spaced apart from each other in a peripheral direction of the main roller and is disposed adjacent to the outer circumferential surface of the main roller.

3. The method according to claim 1, wherein the placing comprises:
placing the susceptor and the electrically conductive track to be spaced apart from each other in a longitudinal direction of the sheet; and
placing the susceptor to be closer to the main roller than the electrically conductive track in the longitudinal direction of the sheet.

4. The method according to claim 1, wherein the placing comprises placing the susceptor and the electrically conductive track on a same surface of the sheet.

5. The method according to claim 1, wherein the rolling comprises rolling the sheet around the main roller so that the susceptor faces the outer circumferential surface of the main roller.

6. The method according to claim 1, wherein the rolling comprises rolling the sheet around the main roller while heating the sheet with the main roller and pressing the sheet with the plurality of sub-rollers.

7. The method according to claim 6, wherein the rolling comprises thermally fusing the susceptor and the electrically conductive track to the sheet while heating the susceptor and the electrically conductive track with the main roller and pressing the susceptor and the electrically conductive track with the plurality of sub-rollers.

8. The method according to claim 6, wherein the rolling comprises:
heating the main roller to a first temperature;
heating at least one of the plurality of sub-rollers to a second temperature lower than or equal to the first temperature; and
heating the sheet rolled around the main roller with the main roller and the plurality of sub-rollers.

9. The method according to claim 6, wherein the rolling comprises pressing the sheet at a pressure of 18 kgf to 22 kgf with the main roller and each of the plurality of sub-rollers.

10. The method according to claim 6, wherein the rolling comprises:
heating the main roller to a temperature of 360° C. to 400° C.; and
heating the sheet rolled around the main roller with the main roller.

11. The method according to claim 6, wherein the rolling comprises rolling the sheet around the main roller for 10 minutes to 14 minutes.

12. The method according to claim 1, wherein the rolling comprises rolling the sheet around the outer circumferential surface of the main roller at least three turns.

13. The method according to claim 12, wherein the rolling comprises:
rolling the sheet around the main roller to form a first layer comprising the susceptor;
forming a second layer comprising the electrically conductive track to be disposed on an outer side of the first layer in a radial direction of the main roller; and
forming at least one third layer using the sheet to be disposed on an outer side of the second layer in the radial direction of the main roller.

14. The method according to claim 13, wherein the third layer forms one to four layers in the radial direction of the main roller.

15. The method according to claim 1, further comprising:
separating the sheet rolled in a hollow shape from the main roller;
assembling a bracket to both open ends of the rolled sheet; and
assembling a casing to a side of the rolled sheet.
